(19) United States
(12) Patent Application Publication
(10) Pub. No.: US 2008/0156803 A1
(43) Pub. Date: Jul. 3, 2008

(54) Beverage containing assembly

(76) Inventors: Ruth McClellan, Pittsfield, PA (US); Brad Bielawski, Warren, PA (US)

Correspondence Address: THE BILICKI LAW FIRM, PC, 1285 North Main Street, JAMESTOWN, NY, 14701, US

(21) Appl. No.: 11/649,436

(22) Filed: Jan. 3, 2007

(51) Int. Cl. B65D 51/18; B23P 19/04; B65D 53/02; B65D 41/04

(52) U.S. Cl. 220/254.1; 220/288; 220/378; 29/700

(57) ABSTRACT

A beverage containing assembly includes a container having an annular side wall, a base and a circular, open upper end defined by a rim. The assembly also includes an adapter portion having an internally threaded annular wall, a circular, open upper end having a diameter smaller than the open upper end of the container, and a lower annular shoulder having an open bottom end. A downwardly facing annular channel is provided for receiving the rim of the container, where the downwardly facing annular channel is adapted to bond to the rim by spin welding. Further, the assembly includes a lid threadably attached to the adapter portion. The lid has an annular side wall with a radially outer thread engageable with the internally threaded annular wall of the adapter. The assembly may also include an annular hill positioned within the annular channel to strengthen the spin welding bond.

### BRIEF DESCRIPTION OF THE DRAWINGS

FIG. 1 is an exploded view of a beverage containing assembly in accordance with one embodiment of the invention.

FIG. 2 is a cross-sectional view of an adapter, cover and closure member threadibly engaged.

FIG. 3 is a side perspective view of a beverage container, adapter, cover and closure member.

FIG. 4 is an enlarged, detailed view of an energy hill and annular shoulder of the adapter as shown in FIG. 2.

FIG. 5 is a side, perspective, exploded view of the cover, closure member and the adapter.

FIG. 6 is a cross-sectional view of an adapter, cover and closure member threadibly engaged, and a cup snap-fittingly engaged.

FIG. 7 is a side perspective view of the cup being snap-fittingly engaged with the adapter.

### DETAILED DESCRIPTION OF EMBODIMENTS OF THE INVENTION

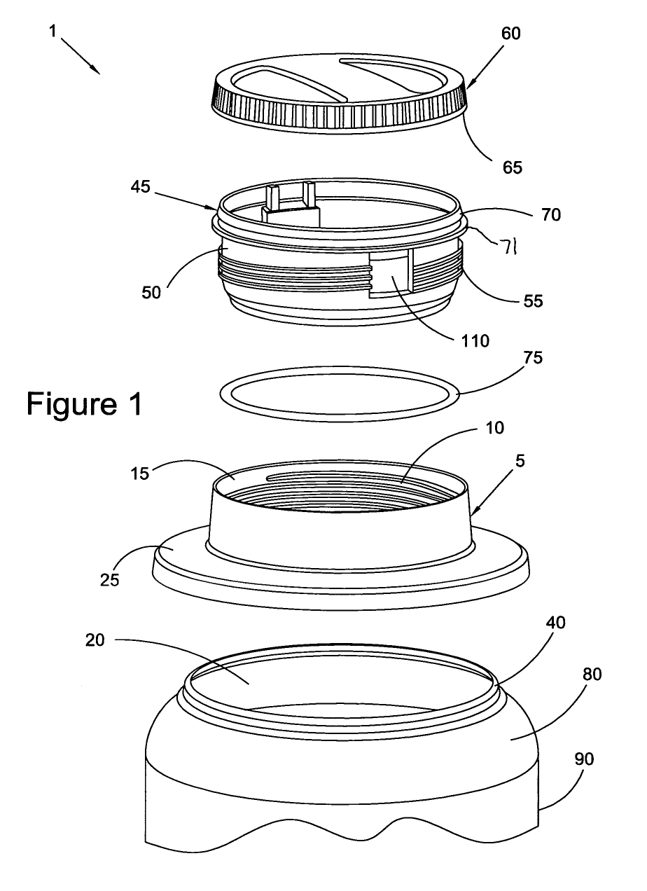

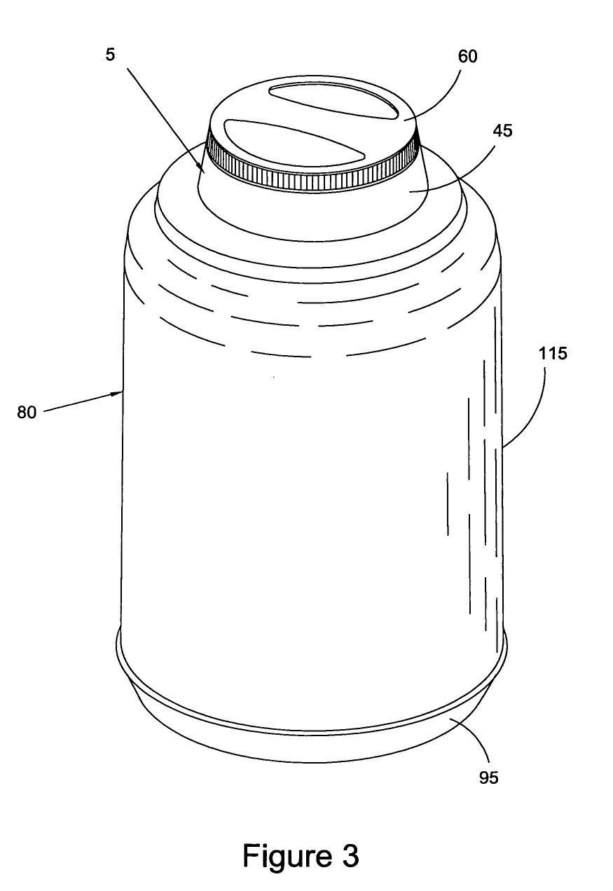

As depicted generally in FIG. 1, a beverage containing assembly 1 is provided. Beverage containing assembly 1 includes a beverage container 80, an adapter 5, a sealing member 75, a closure member 45 and a cover 60. Beverage container 80 may be a double walled molded plastic container having insulation (not shown) positioned between an inner and outer wall to maintain a beverage at a hot or cold temperature. As shown in FIGS. 1 and 3, beverage container 80 includes a base portion 95, an annular side wall 90 having a first diameter (not labeled), a shoulder portion 91, which terminates at a rim 40 defining a circular, open, upper end 20 having a diameter smaller than the first diameter of annular side wall 90. Rim 40 extends upward from shoulder portion 91 and includes an externally protruding lip 41. Beverage container 80 may be any size known in the art, for example 32 ounces, 44 ounces, 52 ounces, 64 ounces, or 100 ounces. One of ordinary skill in the art would readily appreciate that container 80 may be adapted to include a handle, carrying strap or other known means of transport. It should be recognized the beverage container 80 is not limited to the above-described configuration and is only described as an example of an embodiment of the beverage dispensing assembly described herein.

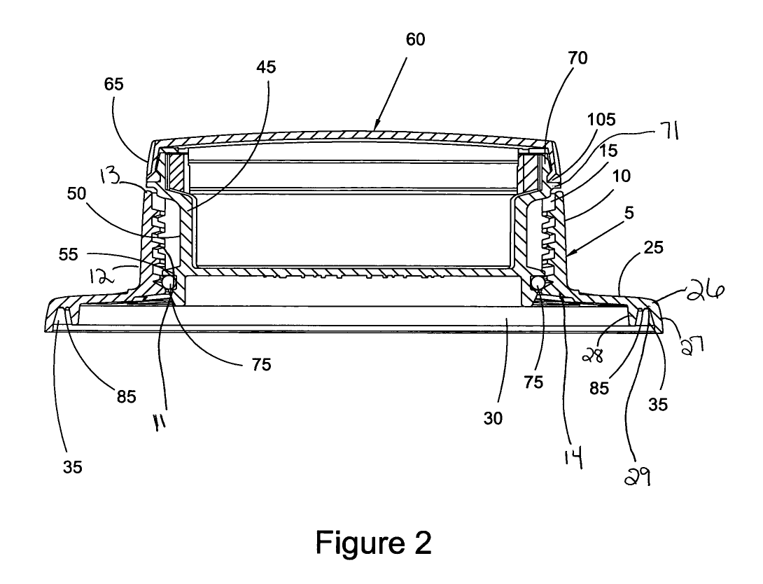

Beverage dispensing assembly 1 also includes an adapter 5 which couples with beverage container 80 to decrease the diameter of the opening, as will be described below, and improve the seal of beverage container 80. Adapter 5 is formed of plastic and is molded by an injection molding process. As shown in FIGS. 1 and 2, adapter 5 includes annular side wall 10 defining an opening 15, which has a diameter smaller than the diameter of open upper end 20 of beverage container 80. Annular side wall 10 includes internal threads 11, a smooth outer surface 12, an upper edge 13 and a lower edge 14. Lower edge 14 of annular side wall 10 leads into a lower annular shoulder 25 having a perimeter 26. Adapter 5 also includes an open bottom end 30. Extending. perpendicularly from perimeter 26 is a U-shaped channel 35 defined by an outer flange 27, an inner flange 28 and a base segment 29 therebetween. Base segment includes a raised hill 85 which may be defined as an energy hill. Channel 35 is adapted to receive rim 40 of container 80 such that container 80 and adapter 5 may be bonded together by spin welding. Spin welding is accomplished by using a commercial spin welding apparatus, having rotational speed variable from 500 to 1500 RPMs and a downward pressure capacity between 100 to 300 lbs. The revolutions necessary to create a seal varies, depending on the diameter of the objects being spin welded. As a result of the spin welding process, U-shaped channel 35 and rim 40 meld together forming a bond. Additional strength is added to the bond by hill 85, which also melds into rim 40, thereby bonding adapter 5 to rim 40.

As shown in FIG. 1, beverage containing assembly 1 further includes a closure member 45 having an annular side wall 50 with outer threads 55 for engaging internally threaded annular wall 10 of adapter 5. Annular side wall 50 also includes a first and second outwardly projecting lips 51 and 52 defining a groove therebetween for retaining a sealing member 75, as shown in FIG. 2. As one of ordinary skill in the art will readily appreciate, sealing member 75 may take the form of any number of sealing mechanisms including, but not limited to, an o-ring. At an upper portion of annular side wall 50 closure member 45 also includes outer annular ridge 70 and an outer annular ledge 71 positioned below outer annular ridge 70. Outer annular ridge 70 and an outer annular ledge 71 are formed such that an inner annular lip 105 of cover 60 may engage closure member 45 by way of a snap-fit. Cover 60 is provided to improve the aesthetic appearance and to increase the ease of cleaning of beverage containing assembly 1. It should be understood that closure member 45 may be formed with an integral top piece (not shown) while including cover 60.

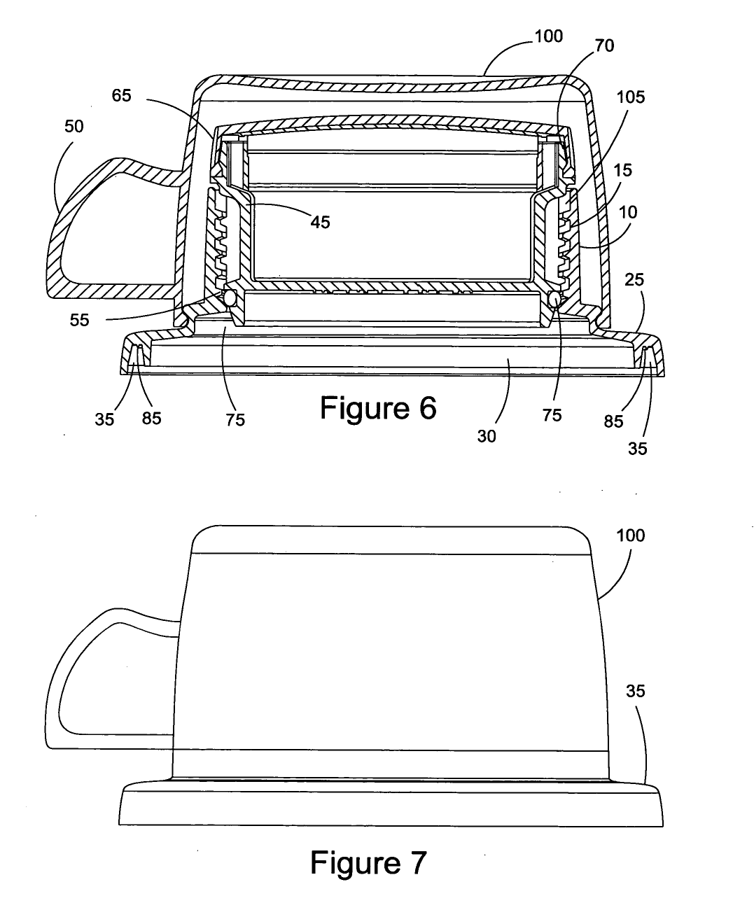

In an alternate embodiment, as shown in FIG. 6 and FIG. 7, a cup 100 is provided as part of beverage dispensing assembly 1. Closure member 45 may include a grove, ridge, or other engagement means for retaining the cup when in a stored position. Cup 100 fits on sidewall 10 via snap fit. One skilled in the art will appreciate that having a cup snap-fittingly attached allows the beverage user to transport both the beverage and the cup as a single unit.

Closure member 45 also includes a cut-out portion 110 within side wall 50. Positioned behind cut-out portion 110 for assisting in the pouring of beverages from beverage containing assembly 1. One having ordinary skill in the art would appreciate that when adapter 5 and closure member 45 are partially, threadibly enagaged (not shown), cut-out portion 110 allows the contents of beverage container 80 (not shown) to be poured out, without having to take closure member 45 off entirely. It should also be appreciated that although one cut-out portion 110 is shown, a plurality of cut-out portions may be included.

FIG. 2 is a cross-sectional view of beverage containing assembly 1 showing adapter 5 in threadable engagement with closure member 45. Internally threaded annular side wall 10 of adapter 5 threadably engages annular side wall 50. Cover 60 is shown in snap-fit engagement with closure member 45. Therefore, cover 60 and closure member 45 are received within circular, open, upper end 15 of the adapter 5.

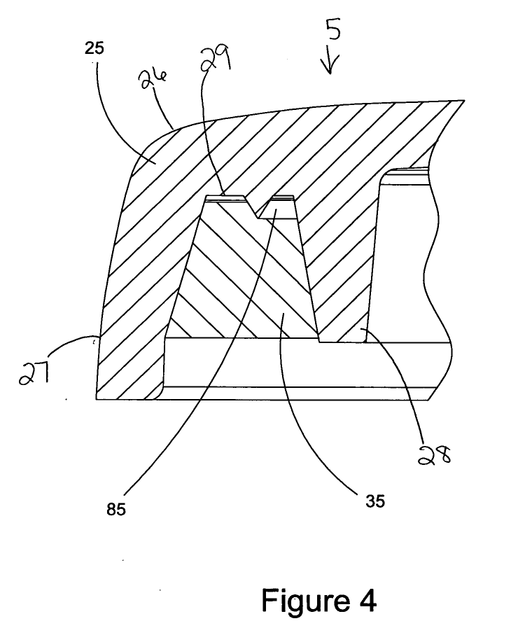

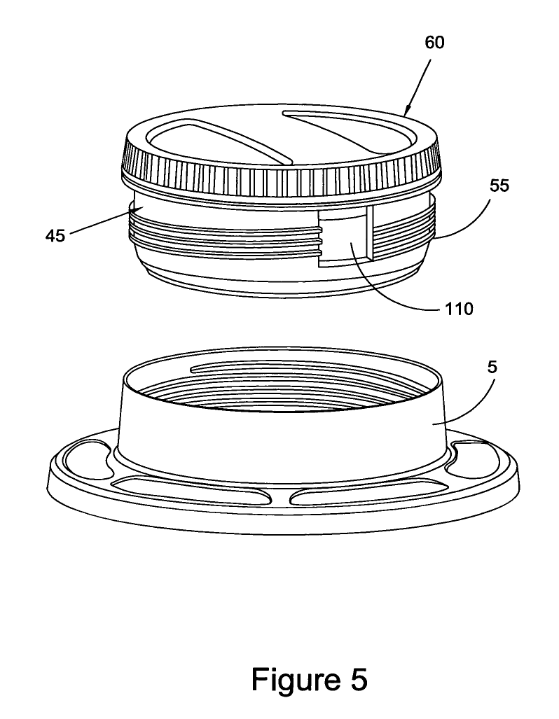

FIG. 4 depicts an enlarged, detailed view of energy hill 85, inside of annular channel 35. The diameter of annular channel 35 is configured such that adapter 5 can be used with beverage containers 80 formed from existing model molds or new molds. A variety of different sized adapters may be made to fit with various standard sized of beverage containers, for example 32 ounces, 64 ounces, or 100 ounces. A variety of standard beverage containers produced from existing molds can receive and be spin welded to adapter 5. Existing container molds can then be used in conjunction with the adapter assembly to yield multiple product lines. By creating different adaptors, one may maximize product lines with minimal molding and minimal design of container 80 molding. In particular, the use of spin welding creates a leak-proof seal so that the beverage containers 80 may be for use with hot beverages, though one of ordinary skill in the art would appreciate that the container and adapter combination would also be appropriate for use with cold beverages.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. While particular forms of the invention have been described, it will be apparent that various modifications can be made without departing from the spirit and scope of the invention. Accordingly, it is not intended that the invention be limited, except as by the appended claims.

We claim:

1. A beverage containing assembly comprising:
a container having an annular side wall, a base and a circular, open upper end defined by a rim;
an adapter portion having an internally threaded annular wall, a circular, open upper end having a diameter smaller than said open upper end of said container, and a lower annular shoulder having an open bottom end and a downwardly facing annular channel for receiving said rim of said container, said downwardly facing annular channel being adapted to bond to said rim by spin welding; and
a lid threadably attached to said adapter portion, said lid having an annular side wall with a radially outer thread engageable with internally threaded annular wall of said adapter.

2. The beverage containing assembly of claim 1 further comprising:
an annular hill positioned within said annular channel, said annular hill adapted to strengthen said spin welding bond.

3. The beverage containing assembly of claim 1 further comprising:
a sealing member positioned between said adapter portion and said lid for sealing said container.

4. The beverage containing assembly of claim 3 wherein said sealing member is an O-ring.

5. The beverage containing assembly of claim 1 further comprising:
a cover including a top surface and a downwardly extending rim, said cover being adapted to snap-fittingly engage said lid.

6. The beverage containing assembly of claim 5, wherein said lid includes an outer annular ridge positioned on an upper portion of said annular side wall for engaging an inner annular ridge positioned on said downwardly extending rim of said cover.

7. The beverage containing assembly of claim 1, wherein said container is defined by an outer wall and an inner wall having a space for insulation therebetween.

8. An adapter and lid assembly for a beverage container having an annular side wall, a base and a circular, open upper end defined by a rim, said adapter and lid assembly comprising:
an adapter portion having an internally threaded annular wall, a circular, open upper end having a diameter smaller than said open upper end of said container, and a lower annular shoulder having an open bottom end and a downwardly facing annular channel for receiving said rim of said container, said downwardly facing annular channel being adapted to bond to said rim by spin welding; and
a lid threadably attached to said adapter portion, said lid having an annular side wall with a radially outer thread engageable with internally threaded annular wall of said adapter portion.

9. The beverage containing assembly of claim 8 further comprising:
a downwardly projecting annular hill positioned within said annular channel, said annular hill adapted to strengthen said spin welding bond.

10. The beverage containing assembly of claim 9 further comprising:
a sealing member positioned between said adapter portion and said lid for sealing said container.

11. The beverage containing assembly of claim 10 wherein said sealing member is an O-ring.

12. The beverage containing assembly of claim 8 further comprising:
a cover including a top surface and a downwardly extending rim, said cover being adapted to snap-fittingly attach to said lid.

13. The beverage containing assembly of claim 12, wherein said lid includes an outer annular ridge positioned on an upper portion of said annular side wall for engaging an inner annular ridge positioned on said downwardly extending rim of said cover.

14. A beverage containing assembly produced by a process comprising:
a.) providing a beverage container having an annular side wall, a base and a circular, open upper end defined by a rim;
b.) molding an adapter portion formed of a polymeric material, said adapter portion having an internally threaded annular wall, a circular, open upper end having a diameter smaller than said open upper end of said container, and a lower annular shoulder having an open bottom end and a downwardly facing annular channel for receiving said rim of said container;
c.) bonding said beverage container to said adapter by positioning said downwardly facing annular channel of said adapter over said rim of said beverage container and spin welding said adapter to said container;
d.) threadably attaching a lid to said adapter portion, said lid having an annular side wall with a radially outer thread engageable with internally threaded annular wall of said adapter portion.

15. The beverage containing assembly of claim 14 wherein said molding step further includes forming a downwardly projecting annular hill positioned within said annular channel, said annular hill adapted to strengthen said spin welding bond.

16. The beverage containing assembly of claim 14 further comprising:
positioning a sealing member positioned between said adapter portion and said lid for sealing said container.

17. The beverage containing assembly of claim 16 wherein said sealing member is an O-ring.

18. The beverage containing assembly of claim 14 further comprising:
snap-fittingly attaching a cover to said lid, said cover including a top surface and a downwardly extending rim.

19. The beverage containing assembly of claim 18, wherein said lid includes an outer annular ridge positioned on an upper portion of said annular side wall for engaging an inner annular ridge positioned on said downwardly extending rim of said cover.
